(19) United States
(12) Patent Application Publication
(10) Pub. No.: US 2026/0343195 A1
(43) Pub. Date: Oct. 29, 2026

(54) METHOD FOR TRANSMITTING MESSAGE IN WIRELESS COMMUNICATION SYSTEM AND DEVICE THEREFOR

(71) Applicant: LG ELECTRONICS INC., Seoul (KR)

(72) Inventors: Jaeho HWANG, Seoul (KR); Hakseong KIM, Seoul (KR); Hanbyul SEO, Seoul (KR)

(21) Appl. No.: 19/103,987

(22) PCT Filed: Aug. 25, 2023
(86) PCT No.: PCT/KR2023/012686

§ 371 Date: Feb. 14, 2025

(30) Foreign Application Priority Data
Aug. 25, 2022 (KR) 10-2022-0107113

(51) Int. Cl. H04W 4/46

(52) U.S. Cl. CPC H04W 4/46

(57) ABSTRACT

According to various embodiments, disclosed are a method for a network to transmit a vehicle to network (V2N) message in a wireless communication system, and a device therefor. The network may match a received virtual message and a vehicle to network (V2N) message, update the matched virtual message and V2N message, and transmit the updated virtual message and V2N message.

### CROSS-REFERENCE TO RELATED APPLICATIONS

This application is a National Phase application under 35 U.S.C. 371 of International Application No. PCT/KR2023/012686, filed on Aug. 25, 2023, which claims the benefit of the Korean Patent Application No. 10-2022-0107113, filed on Aug. 25, 2022, the contents of which are incorporated by reference herein in their entirety.

### TECHNICAL FIELD

The present disclosure relates to a method and apparatus for transmitting a vehicle-to-network (V2N) message by a network in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (BSM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### SUMMARY

An object of the present disclosure is to provide a method and apparatus for effectively providing a SoftV2X-based safety service even in a road and surrounding environment where non-V2X vehicles and VRUs coexist in a SoftV2X system.

It will be appreciated by persons skilled in the art that the objects that could be achieved with the various embodiments of the present disclosure are not limited to what has been particularly described hereinabove and the above and other objects that the various embodiments of the present disclosure could achieve will be more clearly understood from the following detailed description.

According to an aspect, a method of transmitting a message by a network in a wireless communication system may include receiving a virtual vehicle to network (V2N) message including a virtually generated vehicle to everything (V2X) message for an object detected through a sensor from a first device, matching the virtual V2N message with a V2N message received from a second device, updating at least one of the matched virtual V2N message or V2N message based on a result of the matching, and transmitting the updated virtual V2N message and V2N message. The virtual V2N message may include first location information about the object and coverage information about a distance to a closest neighboring object, and the matching between the virtual V2N message and the V2N message may be performed based on the first location information, the coverage information, and second location information included in the V2N message.

Alternatively, based on a distance between the first location information and the second location information being smaller than the distance included in the coverage information, the virtual V2N message matches the V2N message.

Alternatively, based on the distance between the first location information and the second location information being smaller than the distance included in the coverage information to which a first weight is applied, the virtual V2N message matches the V2N message, and the first weight is determined based on a density of neighboring devices of the detected object.

Alternatively, a header of one of the V2N message and the virtual V2N message includes information about a start bit position and a bit length of dummy bits included in payload.

Alternatively, the network specifies positions of the dummy bits in the payload based on the start bit position and the bit length, and updates the one message without decoding the payload based on the specified positions of the dummy bits.

Alternatively, based on the one message being the V2N message, the network extracts bits at positions corresponding to the dummy bits from payload included in the virtual V2N message, and updates the V2N message by replacing the dummy bits with the extracted bits.

Alternatively, a header of one of the V2N message and the virtual V2N message includes information about a start position and a field length of an empty field omitted in payload.

Alternatively, the network specifies a position of the empty field in the payload based on the start position and the field length, and updates the one message without decoding the payload based on the specified position of the empty field.

Alternatively, based on the one message being the virtual V2N message, the network extracts field information at a position corresponding to the empty field from payload included in the V2N message, and updates the virtual V2N message by adding the field information to the empty field.

Alternatively, the virtual V2N message and the V2N message include payload for a personal safety message (PSM) or basic safety message (BSM) related to vehicle to vehicle communication.

According to another aspect, a network for transmitting a message in a wireless communication system may include a radio frequency (RF) transceiver, and a processor connected to the RF transceiver. The processor may control the RF transceiver to receive a virtual V2N message including a virtually generated V2X message for an object detected through a sensor from a first device, match the virtual V2N message with a V2N message received from a second device, update at least one of the matched virtual V2N message or V2N message, and transmit the updated virtual V2N message and V2N message. The virtual V2N message may include first location information about the object and coverage information about a distance to a closest neighboring object, and the virtual V2N message may be matched with the V2N message based on the first location information, the coverage information, and second location information included in the V2N message.

According to another aspect, a chipset for transmitting a V2N message in a wireless communication system may include at least one processor, and at least one memory operatively connected to the at least one processor and when executed, causing the at least one processor to perform operations. The operations may include receiving a virtual V2N message including a virtually generated V2X message for an object detected through a sensor from a first device, matching the virtual V2N message with a V2N message received from a second device, and updating at least one of the matched virtual V2N message or V2N message, and transmitting the updated virtual V2N message and V2N message. The virtual V2N message may include first location information about the object and coverage information about a distance to a closest neighboring object, and the virtual V2N message may be matched with the V2N message based on the first location information, the coverage information, and second location information included in the V2N message.

According to another aspect, a method of transmitting a V2N message to a network by a first device in a wireless communication system may include generating a virtual V2X message for an object detected through a sensor, and transmitting a virtual V2N message including the virtual V2X message to the network. The virtual V2N message may include first location information about the object and coverage information about a distance to a closest neighboring object, the virtual V2N message may be updated based on another V2N message matched by the network, and the virtual V2N message may be matched with the other V2N message by the network based on the first location information, the coverage information, and second location information included in the V2N message.

According to another aspect, a first device for transmitting a V2N message to a network in a wireless communication system may include an RF transceiver and a processor connected to the RF transceiver. The processor may generate a virtual V2X message for an object detected through a sensor, and control the RF transceiver to transmit a virtual V2N message including the virtual V2X message to the network. The virtual V2N message may include first location information about the object and coverage information about a distance to a closest neighboring object, the virtual V2N message may be updated based on another V2N message matched by the network, and the virtual V2N message may be matched with the other V2N message by the network based on the first location information, the coverage information, and second location information included in the V2N message.

Various embodiments may effectively provide a SoftV2X-based safety service even in a road and surrounding environment where non-V2X vehicles and VRUs coexist by generating and transmitting a virtual V2N message for a device or vehicle detected by an RSU in a SoftV2X system.

Alternatively, a SoftV2X server may mutually complement and retransmit a matched V2N message and virtual V2N message, thereby significantly improving the performance of the V2N message and providing an efficient SoftV2X service.

Alternatively, the matched V2N messages may be quickly and effectively complemented with each other and/or updated without an encoding/decoding procedure by additionally defining indication information about bits or a field position for information not filled in a V2N header of a V2N message.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

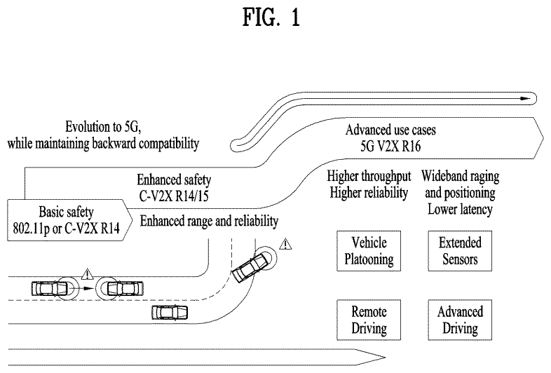

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 is a diagram for explaining an ITS station reference architecture.

FIG. 10 illustrates an exemplary structure of an ITS station that may be designed and applied based on a reference architecture.

FIGS. 11 to 14 are diagrams illustrating a method of transmitting a virtual V2N message generated from an RSU by a SoftV2X server.

FIG. 15 is a diagram illustrating the structure of a virtual V2N message generated by a SoftRSU.

FIG. 16 is a diagram illustrating a method of matching a V2N message from an object with a virtual V2N message.

FIGS. 17 and 18 are diagrams illustrating methods of complementing/updating a V2N message and a virtual V2N message which are matched.

FIG. 19 is a simplified block diagram illustrating a SoftV2X server that complements/updates a V2N message.

FIG. 20 is a diagram illustrating a method of transmitting a V2N message to devices by a network.

FIG. 21 is a diagram illustrating a method of transmitting a V2N message to a network by a first device.

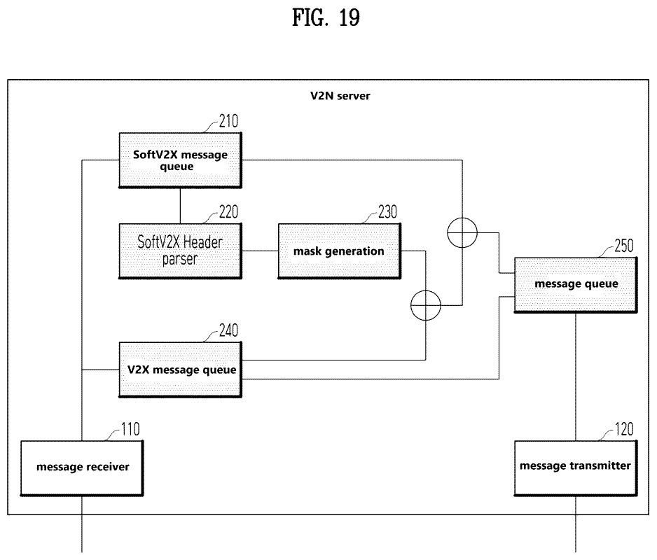

FIG. 22 illustrates a communication system applied to the present disclosure.

FIG. 23 illustrates wireless devices applicable to the present disclosure.

FIG. 24 illustrates another example of a wireless device to which the present disclosure is applied.

FIG. 25 illustrates a vehicle or an autonomous driving vehicle applied to the present disclosure

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

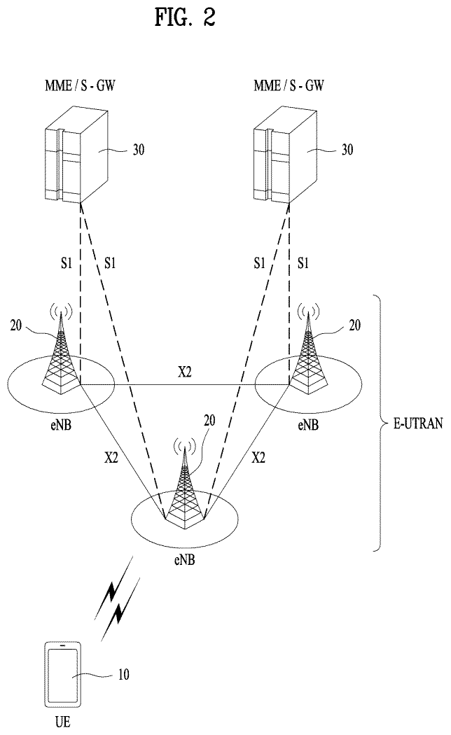

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

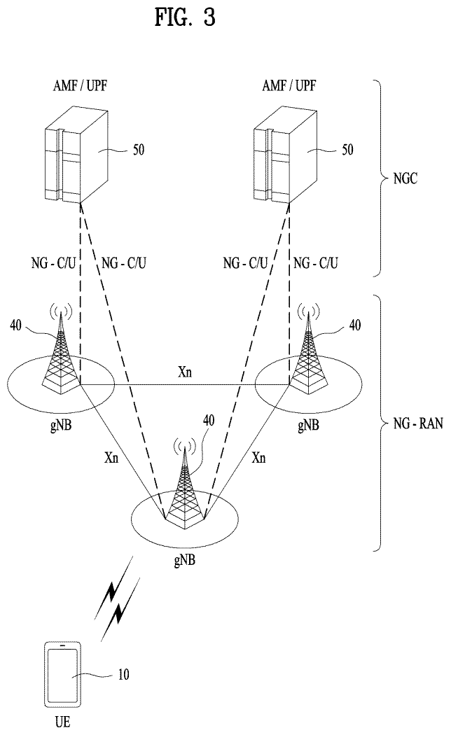

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

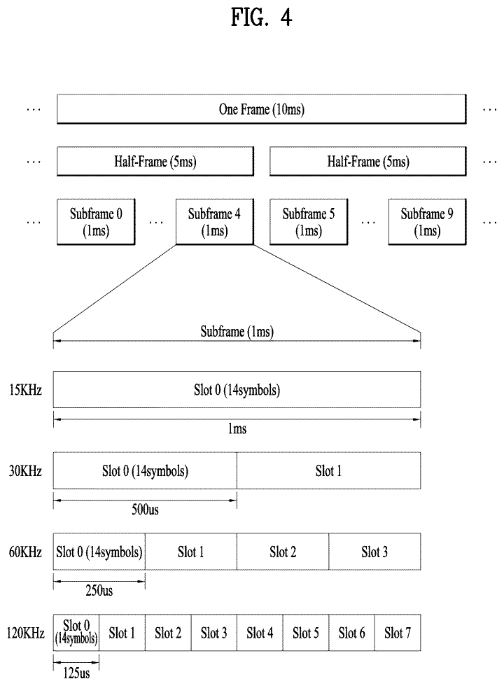

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM (A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μu in the NCP case.

TABLE 1

| SCS (15*2u) | N^{slot}_{symb} | N^{frame,u}ₛₗₒₜ | N^{subframe,u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | Nslotsymb | Nframe, uslot | Nsubframe, uslot |
|---|---|---|---|
| 60 kHz (u = 2) | 12 | 40 | 4 |

In the NR system, different OFDM (A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

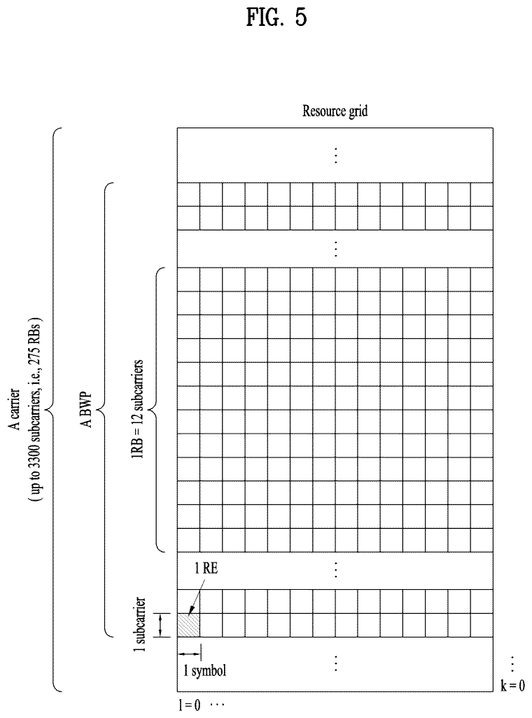

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P) RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

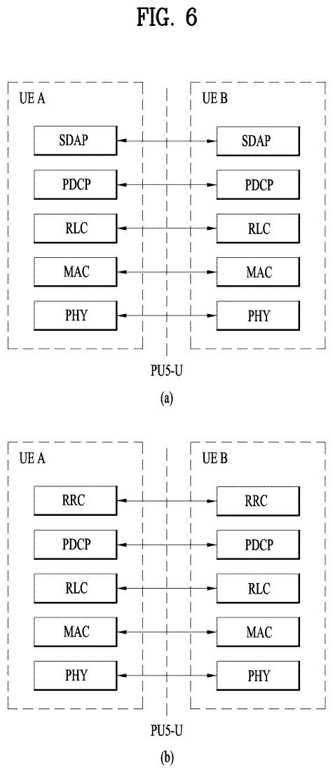

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre) set sidelink BWP (SL BWP). For example, the bandwidth of the S-SSB may be 11 resource blocks (RBs). For example, the PSBCH may span 11 RBs. The frequency position of the S-SSB may be (pre) set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

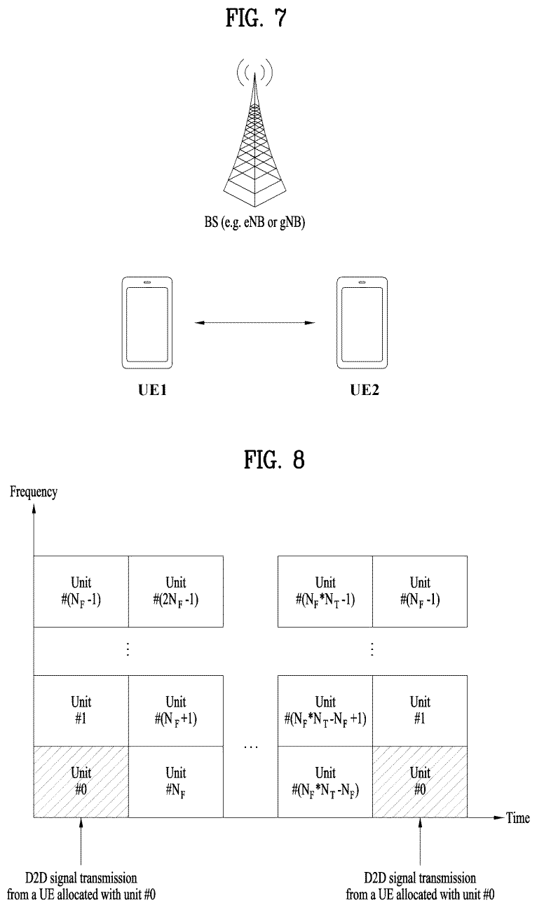

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

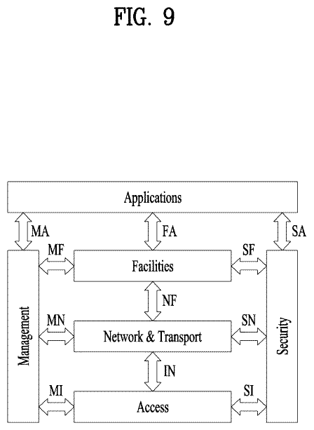

FIG. 8 illustrates resource units for V2X or SL communication.

Referring to FIG. 8, the frequency resources of a resource pool may be divided into NF sets, and the time resources of the resource pool may be divided into NT sets. Accordingly, a total of NF*NT resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

### Vehicular Communications for ITS

An intelligent transport system (ITS) utilizing vehicle-to-everything (V2X) may mainly include an access layer, a network & transport layer, a facilities layer, an application layer, security and management entities, etc. Vehicle communication may be applied to various scenarios such as vehicle-to-vehicle communication (V2V), vehicle-to-network communication (V2N or N2V), vehicle-to-road side unit (RSU) communication (V2I or I2V), RSU-to-RSU communication (I2I), vehicle-to-pedestrian communication (V2P or P2V), and RSU-to-pedestrian communication (I2P or P2I). A vehicle, a BS, an RSU, a pedestrian, etc. as the subjects of vehicle communication are referred to as ITS stations.

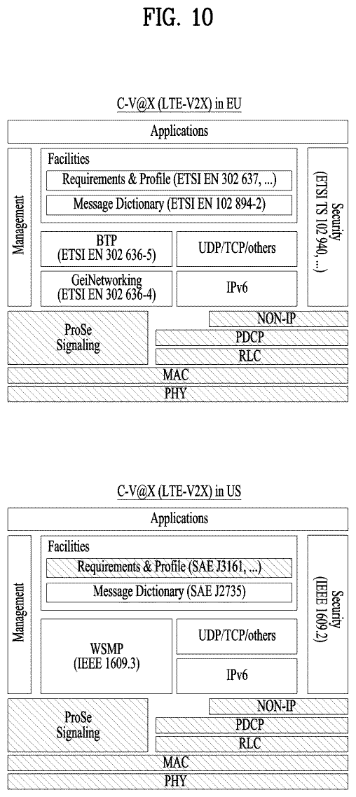

FIG. 9 is a diagram for explaining an ITS station reference architecture.

The ITS station reference architecture may include an access layer, a network & transport layer, a facilities layer, entities for security and management, and an application layer at the top. Basically, the ITS station reference architecture follows a layered OSI model.

Specifically, features of the ITS station reference architecture based on the OSI model are illustrated in FIG. 9. The access layer of the ITS station corresponds to OSI layer 1 (physical layer) and layer 2 (data link layer), the network & transport layer of the ITS station corresponds to OSI layer 3 (network layer) and layer 4 (transport layer), and the facilities layer of the ITS station corresponds to OSI layer 5 (session layer), layer 6 (presentation layer), and layer 7 (application layer).

The application layer, which is located at the highest layer of the ITS station, may actually implement and support a use-case and may be selectively used according to the use-case. The management entity serves to manage all layers in addition to managing communication and operations of the ITS station. The security entity provides security services for all layers. Each layer of the ITS station exchanges data transmitted or received through vehicle communication and additional information for various purposes through an interface. The abbreviations of various interfaces are described below.
MA: Interface between management entity and application layer
MF: Interface between management entity and facilities layer
MN: Interface between management entity and networking & transport layer
MI: Interface between management entity and access layer
FA: Interface between facilities layer and ITS-S applications
NF: Interface between networking & transport layer and facilities layer
IN: Interface between access layer and networking & transport layer
SA: Interface between security entity and ITS-S applications
SF: Interface between security entity and facilities layer
SN: Interface between security entity and networking & transport layer
SI: Interface between security entity and access layer

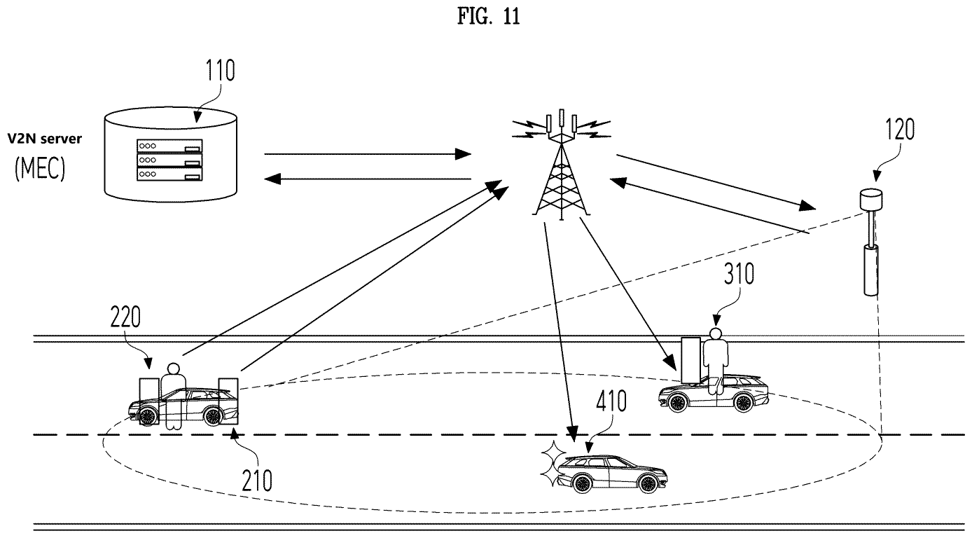

FIG. 10 illustrates an exemplary structure of an ITS station that may be designed and applied based on a reference architecture.

A main concept of the ITS station reference architecture is to allow each layer with a special function to process communication on a layer basis, between two end vehicles/users included in a communication network. That is, when a V2V message is generated, the data is passed through each layer downwards layer by layer in the vehicle and the ITS system (or other ITS-related UEs/systems), and a vehicle or ITS system (or other ITS-related UEs/systems) receiving the message passes the message upwards layer by layer.

The ITS system operating through vehicle communication and the network was organically designed in consideration of various access technologies, network protocols, communication interfaces, etc. to support various use-cases, and the roles and functions of each layer described below may be changed depending on a situation. The main functions of each layer will be briefly described.

The application later actually implements and supports various use-cases. For example, the application layer provides security, efficient traffic information, and other entertainment information.

The application layer controls an ITS station to which an application belongs in various manners or provides services by transferring a service message to an end vehicle/user/infrastructure through the access layer, the network & transport layer, and the facilities layer, which are lower layers of the application layer, by vehicle communication. In this case, the ITS application may support various use-cases. In general, these use-cases may be supported by grouping into other applications such as road-safety, traffic efficiency, local services, and infotainment. Application classification, use-cases, etc. may be updated when a new application scenario is defined. Layer management serves to manage and service information related to operation and security of the application layer, and the related information is transmitted and shared bidirectionally through an MA and an SA (or service access point (SAP), e.g. MA-SAP or SA-SAP). A request from the application layer to the facilities layer or a service message and related information from the facilities layer to the application layer may be delivered through an FA.

The facilities layer serves to support effective implementation of various use-cases defined in an application layer of a higher layer. For example, the facilities layer may perform application support, information support, and session/communication support.

The facilities layer basically supports the 3 higher layers of the OSI model, for example, a session layer, a presentation layer, and the application layer, and functions. Specifically, the facilities layer provides facilities such as application support, information support, and session/communication support, for the ITS. Here, the facilities mean components that provide functionality, information, and data.

The application support facilities support the operation of ITS applications (mainly generation of a message for the ITS, transmission and reception of the message to and from a lower layer, and management of the message). The application support facilities include a cooperative awareness (CA) basic service and a decentralized environmental notification (DEN) basic service. In the future, facilities entities for new services such as cooperative adaptive cruise control (CACC), platooning, a vulnerable roadside user (VRU), and a collective perception service (CPS), and related messages may be additionally defined.

The information support facilities provide common data information or a database to be used by various ITS applications and includes a local dynamic map (LDM).

The session/communication support facilities provide services for communications and session management and include an addressing mode and session support.

Facilities may be divided into common facilities and domain facilities.

The common facilities are facilities that provide common services or functions required for various ITS applications and ITS station operations, such as time management, position management, and service management.

The domain facilities are facilities that provide special services or functions required only for some (one or more) ITS applications, such as a DEN basic service for road hazard warning applications (RHW). The domain facilities are optional functions and are not used unless supported by the ITS station.

Layer management serves to manage and service information related to the operation and security of the facilities layer, and the related information is transmitted and shared bidirectionally through an MF and an SF (or MF-SAP and SF-SAP). The transfer of service messages and related information from the application layer to the facilities layer or from the facilities layer to the application layer is performed through an FA (or FA-SAP), and bidirectional service messages and related information between the facilities layer and the lower networking & transport layer are transmitted by an NF (or NF-SAP).

The network & transport layer servers to configure a network for vehicle communication between homogenous or heterogeneous networks through support of various transport protocols and network protocols. For example, the network & transport layer may provide Internet access, routing, and vehicle networking using Internet protocols such as TCP/UDP+IPv6 and form a vehicle network using a basic transport protocol (BTP) and GeoNetworking-based protocols. In this case, networking using geographic position information may also be supported. A vehicle network layer may be designed or configured depending on technology used for the access layer (access layer technology-independently) or regardless of the technology used for the access layer (access layer technology-independently or access layer technology agnostically).

Functionalities of the European ITS network & transport layer are as follows. Basically, functionalities of the ITS network & transport layer are similar to or identical to those of OSI layer 3 (network layer) and layer 4 (transport layer) and have the following characteristics.

The transport layer is a connection layer that delivers service messages and related information received from higher layers (the session layer, the presentation layer, and the application layer) and lower layers (the network layer, the data link layer, and the physical layer). The transport layer serves to manage data transmitted by an application of the ITS station so that the data accurately arrives at an application process of the ITS station as a destination. Transport protocols that may be considered in European ITS include, for example, TCP and UDP used as legacy Internet protocols, and there are transport protocols only for the ITS, such as the BTS.

The network layer serves to determine a logical address and a packet forwarding method/path, and add information such as the logical address of a destination and the forwarding path/method to a header of the network layer in a packet received from the transport layer. As an example of the packet method, unicast, broadcast, and multicast between ITS stations may be considered. Various networking protocols for the ITS may be considered, such as GeoNetworking, IPv6 networking with mobility support, and IPv6 over GeoNetworking. In addition to simple packet transmission, the GeoNetworking protocol may apply various forwarding paths or transmission ranges, such as forwarding using position information about stations including vehicles or forwarding using the number of forwarding hops.

Layer management related to the network & transport layer serves to manage and provide information related to the operation and security of the network & transport layer, and the related information is transmitted and shared bidirectionally through an MN (or MN-SAP) and an SN (or SN-SAP). Transmission of bidirectional service messages and related information between the facilities layer and the networking & transport layer is performed by an NF (or NF-SAP), and service messages and related information between the networking & transport layer and the access layer are exchanged by an IN (or IN-SAP).

A North American ITS network & transport layer supports IPv6 and TCP/UDP to support existing IP data like Europe, and a wave short message protocol (WSMP) is defined as a protocol only for the ITS.

A packet structure of a wave short message (WSM) generated according to the WSMP includes a WSMP header and WSM data carrying a message. The WSMP header includes Version, PSID, WSMP header extension fields, WSM WAVE element ID, and Length.

Version is defined by a Wsmp Version field indicating an actual WSMP version of 4 bits and a reserved field of 4 bits. PSID is a provider service identifier, which is allocated according to an application in a higher layer and helps a receiver to determine an appropriate higher layer. Extension fields is a field for extending the WSMP header, and includes information such as a channel number, a data rate, and transmit power used. WSMP WAVE element ID specifies the type of a WSM to be transmitted. Length specifies the length of transmitted WSM data in octets through a WSMLength field of 12 bits, and the remaining 4 bits are reserved. LLC Header allows IP data and WSMP data to be transmitted separately and is distinguished by Ethertype of a SNAP. The structures of the LLC header and the SNAP header are defined in IEEE802.2. When IP data is transmitted, Ethertype is set to 0x86DD in the LLC header. When WSMP is transmitted, Ethertype is set to 0x88DC in the LLC header. The receiver identifies Ethertype. If Ethertype is 0x86DD, the receiver transmits upward the packet to an IP data path, and if Ethertype is 0x88DC, the receiver transmits upward the packet to a WSMP path.

The access layer serves to transmit a message or data received from a higher layer on a physical channel. As access layer technologies, ITS-G5 vehicle communication technology based on IEEE 802.11p, satellite/broadband wireless mobile communication technology, 2G/3G/4G (long-term evolution (LTE), etc.)/5G wireless cellular communication technology, cellular-V2X vehicle-dedicated communication technologies such as LTE-V2X and NR-V2X (new radio), broadband terrestrial digital broadcasting technology such as DVB-T/T2/ATSC3.0, and GPS technology may be applied.

A data link layer is a layer that converts a physical line between adjacent nodes (or between vehicles) with noise into a communication channel without transmission error, for use in the higher network layer. The data link layer performs a function of transmitting/delivering/forwarding L3 protocols, a framing function of dividing data to be transmitted into packets (or frames) as transmission units and grouping the packets, a flow control function of compensating for a speed difference between a transmitter and a receiver, and a function of (because there is a high probability that an error and noise occurs randomly in view of the nature of a physical transmission medium) detecting a transmission error and correcting the error or detecting a transmission error based on a timer and an ACK signal by a transmitter in a method such as automatic repeat request (ACK) and retransmitting a packet that has not been correctly received. In addition, to avoid confusion between packets or ACK signals, the data link layer performs a function of assigning a sequence number to the packets and the ACK signals, and a function of controlling establishment, maintenance, and disconnection of a data link between network entities, and data transmission between network entities. The main functions of logical link control (LLC), radio resource control (RRC), packet data convergence protocol (PDCP), radio link control (RLC), medium access control (MAC), and multi-channel operation (MCO) included in the data link layer will be described below.

An LLC sub-layer enables the use of different lower MAC sub-layer protocols, and thus enables communication regardless of network topology. An RRC sub-layer performs functions such as broadcasting of cell system information required for all UEs within a cell, management of delivery of paging messages, management (setup/maintenance/release) of RRC connection between a UE and an E-UTRAN, mobility management (handover), transmission of UE context between eNodeBs during handover, UE measurement reporting and control therefor, UE capability management, temporary assignment of a cell ID to a UE, security management including key management, and RRC message encryption. A PDCP sub-layer may performs functions such as IP packet header compression in a compression method such as robust header compression (ROHC), cyphering of a control message and user data, data integrity, and data loss prevention during handover. RLC sub-layer delivers a packet received from the higher PDCP layer in an allowed size of the MAC layer through packet segmentation/concatenation, increases data transmission reliability by transmission error and retransmission management, checks the order of received data, reorders data, and checks redundancy. A MAC sub-layer performs functions such as control of the occurrence of collision/contention between nodes for use of shared media among multiple nodes, matching a packet delivered from the higher layer to a physical layer frame format, assignment and identification of the address of the transmitter/receiver, detection of a carrier, collision detection, and detection of obstacles on the physical medium. An MCO sub-layer enables efficient provision of various services on a plurality of frequency channels. The main function of MCO sub-layer is to effectively distribute traffic load of a specific frequency channel to other channels to minimize collision/contention of communication information between vehicles in each frequency channel.

The physical layer is the lowest layer in the ITS layer architecture. The physical layer defines an interface between a node and a transmission medium and performs modulation, coding, and mapping of a transport channel to a physical channel, for bit transmission between data link layer entities and informs the MAC sub-layer of whether a wireless medium is busy or idle by carrier sensing or clear channel assessment (CCA).

A Soft V2X system may be a system in which a Soft V2X server receives a VRU message or a personal safety message (PSM) from a vulnerable road user (VRU) or a V2X vehicle and transfers information on a neighbor VRU or vehicle based on the VRU message or the PSM message or may analyze a road condition, etc. on which neighbor VRUs or vehicles move and may transmit a message informing a neighbor VRU or vehicle of a collision warning, etc. based on the analyzed information (e.g., through a downlink signal) via V2X communication using a UU interface. Here, the VRU message may be a message transmitted to the Soft V2X server through the UU interface, and may include mobility information about the VRU, such as a position, a movement direction, a movement path, and a speed of the VRU. That is, the Soft V2X system may use a method of receiving mobility information of VRUs and/or vehicles related to V2X communication through the UU interface and controlling a driving route or a VRU movement flow of the VRU, etc. based on the mobility information received by the Soft V2X server, such as a network. The Soft V2X system may be configured in relation to V2N communication.

User equipment or pedestrian equipment (VRU device) that is difficult to perform direct communication (PC5, DSRC) related to V2X communication can provide or receive driving information and mobility information to nearby vehicles or VRUs through the Soft V2X system based on the UU interface. Through this, the user equipment or pedestrian equipment (VRU device) that is difficult to perform the direct communication (PC5, DSRC) can be protected from surrounding vehicles.

### Method of Generating V2X Message by SoftRSU

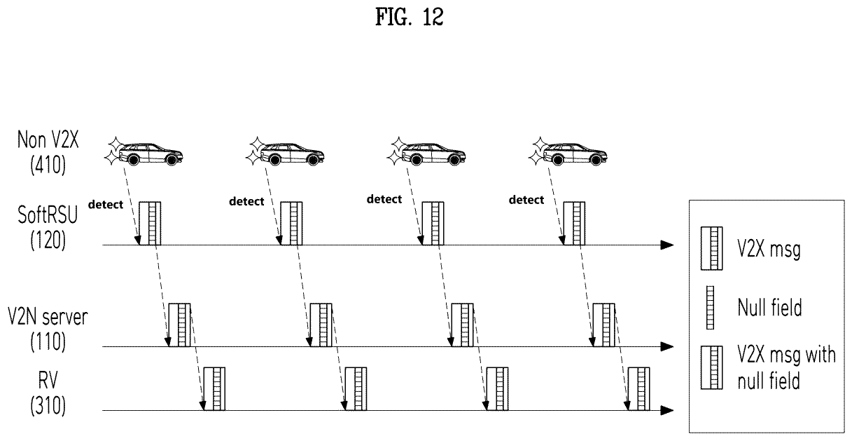

FIGS. 11 to 14 are diagrams illustrating a method of receiving a virtual V2N message generated from an RSU by a SoftV2X server.

A V2N server (or SoftV2X server) 110 may provide a safety service between devices by transmitting V2N messages received from devices located on a road to the devices and their neighboring devices. Referring to FIG. 11, devices 210 and 220 which transmit V2N messages as an in-vehicle device and a UE of a driver, a device 310 which is the only device transmitting a V2N message as a UE of a driver, and a non-V2X vehicle 410 may coexist on the road.

V2X communication provides a safety service between vehicles with V2X devices. However, V2X vehicles, non-V2X vehicles, or vulnerable road users or vulnerable road units (VRUs) may coexist on an actual road. In this case, the non-V2X vehicles with which V2X communication is difficult may require separate handling and processing. For the separate handling and processing, a technology may be considered in which a device (e.g., an RSU 120) installed on a road detects the location of the non-V2X vehicle (or non-V2X device) 410 using a camera or various sensors, and the RSU virtually generates a V2X message (basic safety message (BSM) or personal safety message (PSM)) for the non-V2X device 410 and directly transmits it to the neighboring devices 210, 220, and 310, or transmits a V2N message including the generated V2X message to the SoftV2X server 110. In this case, the SoftV2X server 110 may receive the virtual V2N message generated by the RSU 120 and protect the devices 210, 220, 310, and 410 existing on the road by transmitting the received virtual V2N message to the devices on the road.

Specifically, the RSU (SoftV2X RSU or SoftRSU) 120 having a sensor (camera) may generate a V2N message (including a BSM or PSM for a non-V2X vehicle) for the non-V2X vehicle 410 on behalf of it. In addition, the RSU 120 may also directly generate a virtual V2N message including information obtained by the camera, for each of the V2X vehicles and/or the VRUs. As the RSU 120 transmits the V2N message for the non-V2X vehicle 410, which has been generated by the RSU 120 on behalf of the non-V2X vehicle 410, to the SoftV2X server 110, the non-V2X vehicle 410 may be protected. In addition, the SoftV2X server 110 may significantly improve the performance of the V2N message through message fusion in a manner that adds required information to a conventional V2N message based on the virtual V2N message virtually generated based on data obtained through the sensor in the RSU 120 (and/or in a manner that adds required information to the virtual V2N message).

Hereinafter, a method of directly generating a V2N message (hereinafter, a virtual V2N message) for a target device or target object detected by the RSU 120 (first method), a method of detecting a virtual V2N message and a V2N message matching the virtual V2N message and complementing (or fusing) the matched V2N message and virtual V2N message by the SoftV2X server 110 (second method), and a method of detecting a V2N message transmitted by a neighboring object and generating a virtual V2N message for the neighboring object based on the detected V2N message by the RSU 120 (third method) will be described below in detail.

As the first method for improving the V2N service, a method may be considered in which the RSU 120 generates a V2N message for a (on-road) device estimated or detected through a sensor (camera) and transmits the message to the SoftV2X server 110. For example, the RSU 120 may extract objects related to vehicles and persons from an image obtained through an artificial neural network model, directly generate a virtual V2N message for each of the extracted objects, and transmit it to the SoftV2X server 110.

Referring to FIG. 12, the SoftRSU 120 may recognize or detect the non-V2X vehicle 410 using a sensor, and directly generate a virtual BSM (or V2X message) for the target object based on the location, size, shape, and movement direction of the detected device (or target object). The SoftRSU 120 may transmit a virtual V2N message including the generated virtual BSM to the V2N server or SoftV2X server 110. The SoftV2X server 110 may protect the non-V2X vehicle 410 by transmitting the virtual V2N message to neighboring remote vehicles (RVs) and/or devices. However, the virtual V2N message may additionally include identification information identifying that the message has been generated by the SoftRSU 120 on behalf of the non-V2X vehicle 410. The SoftV2X server 110 and the neighboring devices (the RV 310) may identify from the identification information that the V2N message has been virtually generated in a vicarious manner.

Referring to FIG. 13, in the second method, a V2N message including a PSM or BSM provided by a user's UE (or smartphone) 220 and a V2N message transmitted from an on-board unit (OBU) 210 included in a vehicle may be combined with each other.

Specifically, the BSM or PSM generated by the UE 220 may not include status information (e.g., transmission, brakes, angle, and size) about the vehicle. In this case, the SoftRSU 120 may identify that the UE 220 and the OBU 210 are devices at the same location (or for the same vehicle) and transmit matching information about them to the V2N server 110. In this case, the V2N server 110 may combine the V2N messages between the UE 220 and the OBU 210 based on the matching information. For example, the V2N server 110 may identify that the two V2N messages from the UE 220 and the OBU 210 are matched through the SoftRSU 120. In this case, the V2N server 110 may complement or update the V2N message of the UE 220 based on the matched V2N message of the OBU 210 and transmit the complemented or updated V2N message. For example, the V2N message of the UE 220 may have a field related to the vehicle set to a null value, and the V2N server 110 may reflect the value of a field corresponding to the field set to the null value in the V2N message of the OBU 210 in the V2N message of the UE 220. In this case, the OBU 210 and/or neighboring devices (the RV 410) around the UE 220 may receive the V2N message of the UE 220 including field information for vehicle information such as a vehicle size.

Alternatively, in the third method, the SoftRSU 120 may receive a V2N message (and/or a V2X message) transmitted by a target device sensed or detected in the vicinity, and generate a virtual V2N message for the target device based on the received V2N message on behalf of the target device.

Specifically, referring to FIG. 14, when the SoftRSU 120 generates a virtual V2N message for a detected neighboring device (the SoftV2X device 310), the SoftRSU 120 may also receive a V2N message or SoftV2X message transmitted from the device 310 related to the virtual V2N message. Upon detection of the V2N message transmitted from the device 310, which matches the virtual V2N message, the SoftRSU 120 may complement a field including insufficient information or a null value in the virtual V2N message based on the detected V2N message. The SoftRSU 120 may transmit the virtual V2N message complemented with the V2N message transmitted from the device 310 to the V2N server 110, and neighboring devices (the RV 410) may receive the complemented virtual V2N message through the V2N server 110. The virtual V2N message may additionally include identification information identifying that it is a message matching (or a duplicate message of) the V2N message transmitted from the device 310, and the neighboring device 410 may identify that the virtual V2N message and the V2N message transmitted from the device 310 are messages for the same vehicle based on the identification information. Accordingly, the problem that upon receiving the virtual V2N message and the V2N message transmitted from the device 310, the neighboring device 410 may recognize the vehicle as two vehicles may be eliminated.

The structure of a virtual V2N message generated for a device sensed or detected by the SoftRSU 120 as described above will be described below in detail.

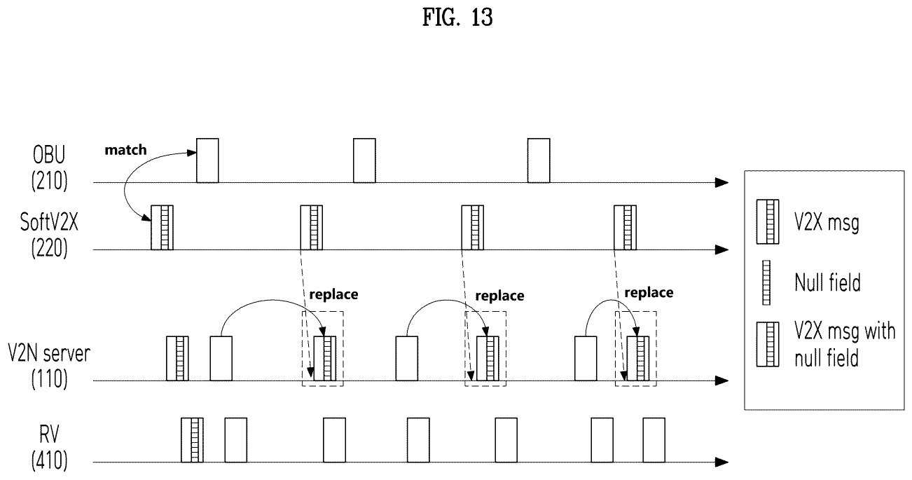

FIG. 15 is a diagram illustrating the structure of a virtual V2N message generated by a SoftRSU.

Referring to FIG. 15, the virtual V2N message (or a V2N message generated by the SoftRSU) may include V2NHeader, ExtensionData and V2N Payload. As in the first method described above, the SoftRSU may generate a virtual V2N message based on a detected/extracted device (object). In this case, the SoftRSU may further include, in the virtual V2N message, an identifier that distinguishes a V2N message directly generated and transmitted by the detected device (or a V2N message including a V2X message such as a directly generated BSM and/or the V2X message) from the virtual V2N message. For example, MessageType in the V2N Header of the virtual V2N message may distinguish the virtual V2N message (or virtual BSM) from the V2N message (or BSM) directly generated by the detected device. For example, MessageType may be set to a value of 3 in the virtual V2N message (virtual V2N message including the BSM as payload), as illustrated in FIG. 15.

Alternatively, in relation to the above-described second method and/or third method, the V2N message (or SoftRSU message) may provide an additional function and/or additional information related to matching (e.g., matching between the virtual V2N message and the V2N message generated by the corresponding device) through an extension field. For example, the additional function or additional information related to the matching may be provided by extensionFlag set to 6 or 7 in the V2N message (through extensiondata). For example, when the SoftRSU identifies direct matching by its own matching algorithm, the SoftRSU may use extensionFlag (6) to indicate information of mandatory fields (secMark, msgCnt, ID, and Position) of the V2X message (or V2N message) used (for matching) and/or a matching ratio in %. Alternatively, the SoftRSU may use extensionFlag (7) to indicate information about coverage in which neighboring vehicles of the detected device (or object) are located, thereby reducing a mismatching rate in the SoftV2X server.

A method of matching a virtual V2N message and a V2N message based on coverage information included in extensionFlag (7) by the SoftV2X server will be described in detail. The SoftV2X server may also match a V2N message transmitted by the OBU of a vehicle and a V2N message transmitted by the UE of a user riding in the vehicle according to the method described below.

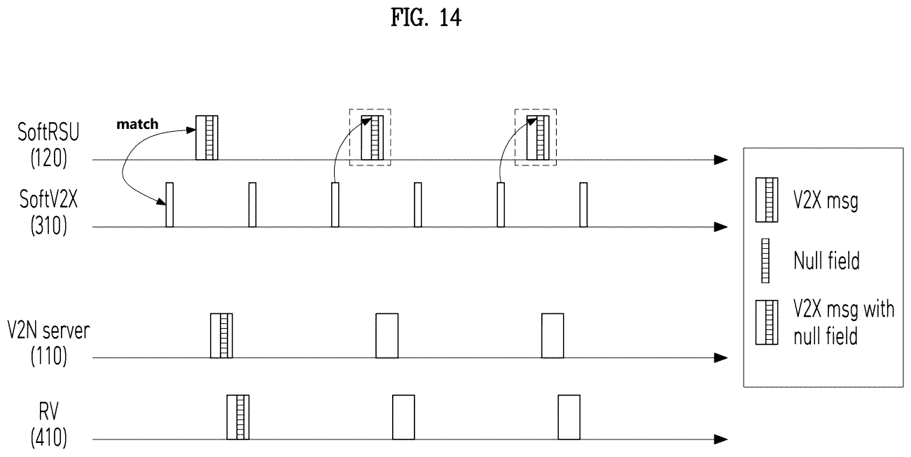

FIG. 16 is a diagram illustrating a method of matching between a V2N message of an object and a virtual V2N message.

Referring to FIG. 16(a), the locations of target objects or target devices that the SoftRSU has detected using a sensor may be represented by black squares. Location information about a target object needs to be matched with a first object

$${V}_{1}^{V 2 X}$$

and/or second object

$${V}_{2}^{V 2 X}$$

identified through V2X messages received by the SoftRSU (or V2N messages directly transmitted by the objects). For this matching, the SoftRSU may additionally provide coverage information about a range in which other neighboring objects exist in the surroundings, when a virtual V2N message for the target object or target HV is generated. The coverage information may include information about a distance from the target object HV to the nearest device or object RV. The SoftV2X server may operate a matching algorithm based on the coverage information included in the virtual V2N message.

For example, as illustrated in FIGS. 16(b) and 16(c), even if the distance between the location of the target object (a detected location or the location of the target object included in the virtual V2N message) and the location of a device identified through a received V2N message is the same, the matching result between the target object and the identified device may be different depending on the coverage information (the distance to a neighboring object).

Specifically, the SoftV2X server may identify/determine whether the virtual V2N message and the V2N message (i.e., the V2N message directly transmitted by the target object) are matched based on the coverage information included in the virtual V2N message using the following Equation 1. Herein, Distance may represent the distance between the location of the target device included in the virtual V2N message and the location of the identified device included in the received V2N message (or identified V2N message) witch which matching is to be determined, and α_{coverage} (or a first weight) may be a weight adjusted according to a surrounding environment related to the target object. For example, the value of α_{coverage} may decrease as the density of neighboring devices of the target object increases, and increase as the density of neighboring devices of the target object decreases. α_{coverage} may be directly determined by the SoftV2X server or provided through the virtual V2N message.

$$matching = \{ \begin{matrix}1 , & if Distance \geq {α}_{coverage} \times Coverage \\ 0 , & if Distance < {α}_{coverage} \times Coverage\end{matrix} \qquad [ Equation 1 ]$$

When a matching value between the virtual V2N message and the identified V2N message is 0 according to Equation 1, the SoftV2X server may determine that the virtual V2N message and the identification V2N message (or the target object and the identified object) match each other, and when the matching value is 0, the SoftV2X server may determine that the virtual V2N message and the identification V2N message (or the target object and the identified object) do not match each other.

The location of the first object

$${V}_{1}^{V 2 X}$$

obtained from the received V2X message may also have an error in a positioning system such as the GPS. The SoftV2X server may determine whether the messages are matched by Equation 2 that reflects the error of the positioning system. Herein, β_{confidentialLevel} (or a second weight) is a parameter value set based on the reliability/accuracy of the GPS, and may be obtained from the identified V2N message (i.e., the V2N message directly generated and transmitted by the identified device).

$$matching = \{ \begin{matrix}1 , & if Distance \geq {α}_{coverage} \times {β}_{confidentialLevel} \times Coverage \\ 0 , & if Distance < {α}_{coverage} \times {β}_{confidentialLevel} \times Coverage\end{matrix} \qquad [ Equation 2 ]$$

When a matching value between the virtual V2N message and the identified V2N message is 0 according to Equation 2, the SoftV2X server may determine that the virtual V2N message and the identification V2N message (or the target object and the identification object) match each other, and when the matching value is 1, the SoftV2X server may determine that the virtual V2N message and the identified V2N message (or the target object and the identification object) do not match each other.

As described above through the third method, the SoftV2X server may use an extensionFlag5=FieldPoint value for rapid complementation/update of mapped V2N messages (or for rapid data fusion).

Generally, a V2X message transmitted by a device (included in a V2N message) may be encoded through abstract syntax notation one (ASN.1). As described above, the V2X message may be included in the payload of a V2N message transmitted by the device (vehicle) to the SoftV2X server. In this case, for mutual data complementation between two matched messages (a virtual V2N message and an identified V2N message), the SoftV2X server needs to perform ASN.1 decoding on the V2X message included in each of the identified V2N message and the virtual V2N message, perform data complementation (or update a data field), and then perform ASN.1 encoding again to generate a V2X message. This ASN.1 decoding/encoding operation may cause a delay in the complementation process, and the delay may not be proper for the safety service between vehicles.

Methods of minimizing a delay caused by the decoding/encoding operation will be described below in detail.

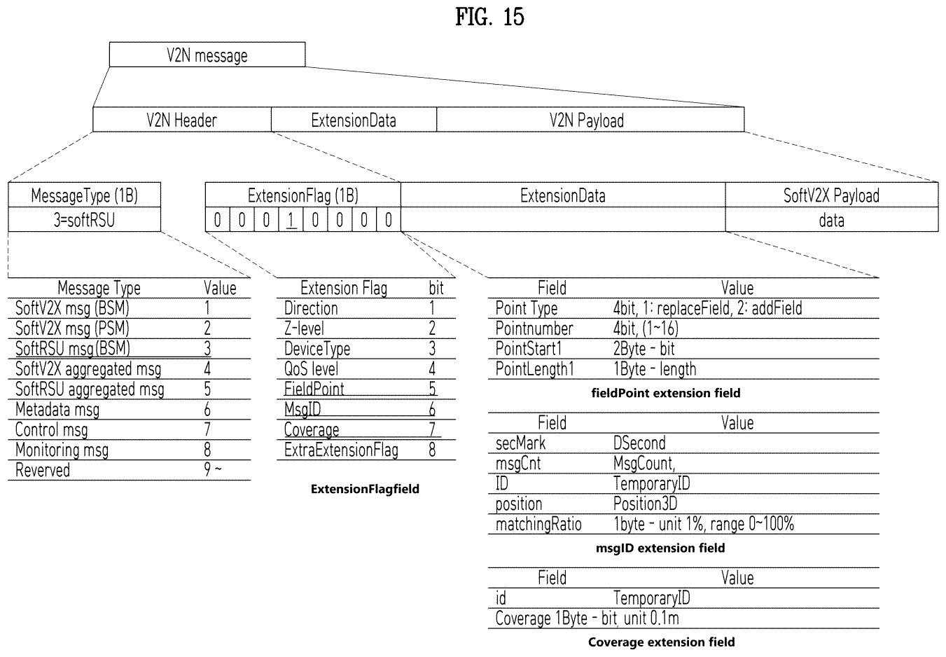

FIGS. 17 and 18 are diagrams illustrating methods of complementing/updating a V2N message and a virtual V2N message which are matched.

To prevent a delay caused by the above decoding/encoding operation, a method of exchanging/complementing/adding data in bits based on PointType, PointNumber, PointStart, and/or PointLengh of the FieldPoint extension field (e.g., fields defined in the V2N header of each of the virtual V2N message and the identified V2N message) may be considered. This method of exchanging/complementing/adding data in bits does not require a decoding/encoding operation such as ASN.1 for a V2X message.

Specifically, the SoftV2X server may complement/update the V2N message by using either a method of replacing (additional) data requiring complementation (replaceField method) or a method of inserting (additional) data requiring complementation (AddField method), through PointType included in the V2N header.

The replaceField method will be described with reference to FIG. 17, and the AddField method will be described in detail with reference to FIG. 18. Up to 16 fields may be added to the V2N header through PointNumber, and as many PointStart and PointLength fields as the number of the added fields may be included in the V2N header.

In the ReplaceField method, a null field including dummy bits may be transmitted. For example, in the ReplaceField method, dummy bits may be inserted into at least one field (e.g., a null field) that does not have corresponding information among predefined fields for the BSM/PSM (or V2X message) included in the payload of a virtual V2N message (or a V2N message). In this case, the SoftV2X server may exchange the dummy bits with data extracted from the other matched V2N message without performing a separate encoding/decoding operation, based on position information about the null field. This method has the advantage that the size of the payload (or V2X message) included in the V2N message does not change before and after the data exchange.

For example, referring to FIG. 17, a BSM or V2X message generated by a SoftV2X UE (or smartphone) may not include information corresponding to a field for a vehicle size. The SoftV2X UE may transmit, to the SoftV2X server, a first V2N message including payload (a V2X message or BSM) in which the field for the vehicle size is filled with dummy bits. In this case, the SoftV2X server may determine a virtual V2N message generated by the SoftRSU for a vehicle (or a second V2N message directly transmitted by the vehicle at a location matching the location of the SoftV2X UE) that matches the location of the SoftV2X UE through the above-described matching operation, and the virtual V2N message may include a field including information about the size of the vehicle. In this case, the SoftV2X server may identify/specify a bit position at which the field for the vehicle size is located in each of the first V2N message and the virtual V2N message based on the V2N header of each of the first V2N message and/or the virtual V2N message (or the second V2N message). For example, the SoftV2X server may identify/specify the positions of bits corresponding to the field for the vehicle size through PointType, PointNumber, PointStart and/or PointLengh of the FieldPoint extension field included in the V2N header. The SoftV2X server may obtain/extract bits (or data) for the field for the vehicle size from the virtual V2N message, based on the positions of the identified/specified bits, and replace null bits (or a null field) for the vehicle size in the first V2N message with the obtained/extracted bits (or data). For example, the SoftV2X server may identify/specify the start position of the dummy bits included in the V2N payload of the first V2N message based on PointStart included in the header of the first V2N message, and the length of the dummy bits through PointLength.

For example, the SoftV2X server may receive a first V2N message from the SoftV2X UE and a virtual V2X message from the SoftRSU. The SoftV2X server may determine that the first V2N message and the virtual V2X message match each other by Equation 1 and/or Equation 2. In this case, the SoftV2X server may identify/specify the positions of dummy bits in the payload of the first V2N message from the header of the first V2N message, and obtain/extract bits at positions corresponding to the positions of the dummy bits from the virtual V2N message. In this case, the SoftV2X server may replace the dummy bits included in the V2N message with the obtained/extracted bits. In addition, a null field including dummy bits may also be included in the virtual V2N message. In this case, the SoftV2X server may specify/identify the positions of the dummy bits (null field) in the payload of the virtual V2N message based on the header of the virtual V2N message, and obtain/extract bits at bit positions corresponding to the dummy bits (i.e., bits having the same positions as the specified dummy bits) in the payload of the first V2N message from the first V2N message. The SoftV2X server may replace the dummy bits included in the virtual V2N message with the obtained/extracted bits. As such, the SoftV2X server may identify whether dummy bits or a null field is included in each of a V2N message and a virtual V2N message based on the header of the message, and when identifying that the dummy bits are included, the SoftV2X server may identify the positions of the dummy bits through PointStart and/or PointLengh included in the V2N header of the message, and complement the V2N messages with each other based on the positions of the dummy bits.

Alternatively, referring to FIG. 18, in the AddField method, a V2N message or SoftV2X message with a VehicleSize field not filled may be transmitted. The SoftV2X server may specify/identify the position of the empty field (e.g., the VehicleSize field) through PointStart and PointLength included in the header of the first V2N message. The SoftV2X server may extract/obtain a field (or field data) corresponding to the position of the specified/identified empty field from a virtual V2N message matched with the first V2N message, and insert the obtained field (or field data) into the empty field.

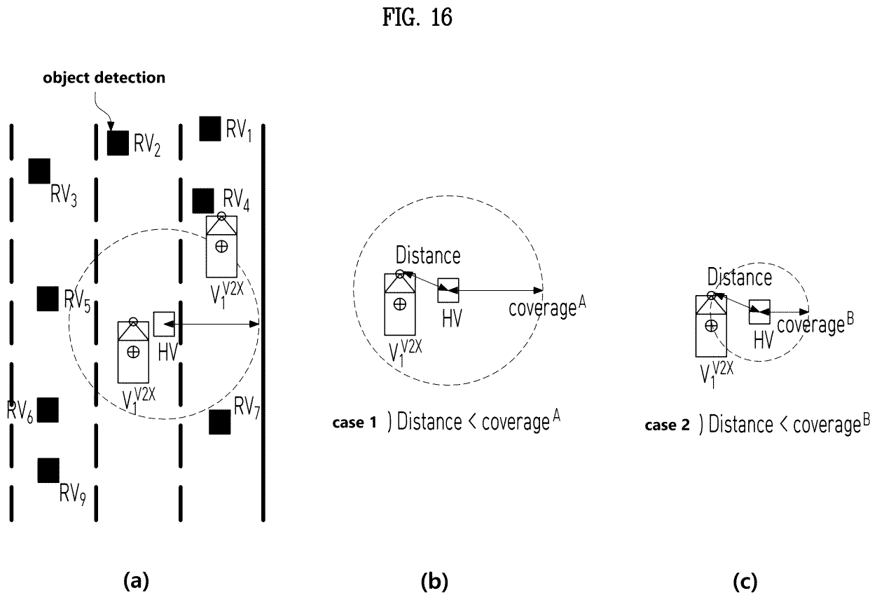

FIG. 19 is a block diagram illustrating a SoftV2X server device that performs an operation of complementing/updating a V2N message.

Referring to FIG. 19, the SoftV2X server may include a message receiver 110, a message transmitter 120, a SoftV2X message queue 210, a SoftV2X header parser 220, a mask generator 230, a V2X message queue 240, and a message queue 250.

Specifically, the SoftV2X server may detect a V2N message (or a SoftV2X message) and a virtual V2N message (or a matching V2N message) that match each other, input a V2N message with a specific field which is empty or filled with dummy bits out of the matched first V2N message and virtual V2N message to the SoftV2X message queue 210, and input the other V2N message (or a V2X message included in the other V2N message) including bits corresponding to the empty field or dummy bits to the V2X message queue 240. The SoftV2X header parser 220 extracts a SoftV2X header from the one V2N message and identifies/specifies the position of the empty field or the position of the dummy bits from the SoftV2X header (StartPoint and StartLength), and the mask generator 230 may generate a mask corresponding to the identified/specified position of the empty field and/or position of the dummy bits. Thereafter, the SoftV2X server may extract bits or data from the other V2N message using the generated mask, and generate a complemented V2N message obtained by inserting the extracted bits or data into the empty field or replacing the dummy bits with the extracted bits or data in the one V2N message. The SoftV2X server may input the complemented V2N message into the message queue 250 to transmit or forward the complemented V2N message to neighboring devices through the message transmitter 120.

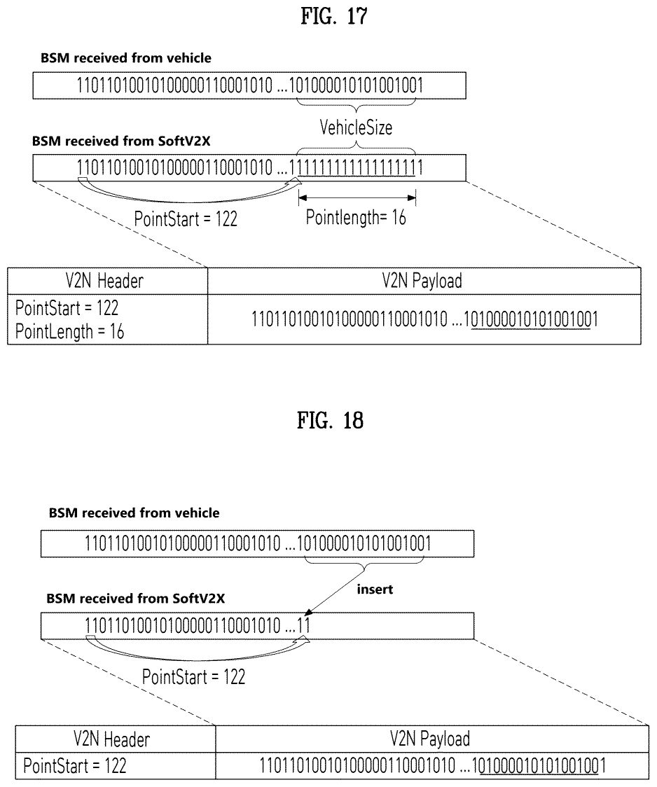

FIG. 20 is a diagram illustrating a method of transmitting a V2N message by a network.

As described above, the network may be a SoftV2X server, and provide services related to V2X by receiving V2N messages including V2X messages from devices including vehicles, UEs, and VRUs to provide a SoftV2X service, and providing or forwarding the received V2N messages to neighboring devices corresponding to the devices.

Referring to FIG. 20, the network may receive a virtual V2N message from a first device (S201). The virtual V2N message may be a V2N message which an RSU (or SoftRSU) virtually generates for an object (hereinafter, a target object), such as a vehicle, (on a road) detected using a sensor such as a camera, and transmits to the network, as described with reference to FIGS. 11 to 19. As described above, the virtual V2N message may include, as payload, a V2X message for a PSM or BSM which is predicted/estimated to be generated by the target object.

Subsequently, the network may receive a V2N message (or a received V2N message) from a second device and determine whether the received V2N message and the virtual V2N message match each other (S203). Alternatively, the network may receive received V2N messages transmitted by devices other than the RSU and determine a matching V2N message that matches the virtual V2N message among the received V2N messages. The second device may be an OBU or VRU UE of a vehicle that transmits a directly generated V2N message in a specific geographical area where the target object is located. In addition, the matching of the V2N message and the virtual V2N message may be whether the virtual V2N message and the V2N message are for the same or corresponding device as described above. For example, when the received V2N message is determined to have been generated by a device corresponding to the target object of the virtual V2N message, the network may identify/determine that the V2N message and the virtual V2N message match each other.

Specifically, the network may determine whether the virtual V2N message matches the V2N message based on first location information and coverage information included in the virtual V2N message, and second location information included in the V2N message. The coverage information may include information about the distance between the target object and its closest other object, as described with reference to FIG. 16. For example, the RSU may detect a plurality of objects in a specific geographical area such as a road through a sensor such as a camera, calculate a distance to the closest other object among objects located around the target object, and generate the coverage information including the calculated distance.

For example, the network may calculate a first distance, which is a distance between the first location information and the second location information and compare the first distance with a second distance, which is a distance included in the coverage information, to determine whether the virtual V2N message and the V2N message match each other. For example, when the first distance is less than or equal to (or is less than) the second distance, the network may determine/estimate that the virtual V2N message and the V2N message match each other (e.g., messages for the same corresponding device). On the contrary, when the first distance is greater than (or is equal to or greater than) the second distance, the network may determine/estimate that the virtual V2N message and the V2N message do not match each other (e.g., messages for different devices).

Alternatively, for each of the received V2N messages, the network may calculate the first distance, which is the distance between the first location information and the second location information and compare the first distance with the second distance, which is the distance included in the coverage information, and thus determine/detect a received V2N message that matches the virtual V2N message among the received V2N messages. For example, the network may determine a received message that matches the virtual V2N message among the received messages, in which the first distance is less than or equal to (or is less than) the second distance.

Alternatively, the network may perform matching between the V2N message and the virtual V2N message by additionally considering the first weight & coverage determined based on the density of neighboring devices of the target object and/or the second weight β_{confidentialLevel} determined based on the accuracy of the second location information included in the V2N message or the error rate (GPS error) of the positioning system, as in Equation 1 and/or Equation 2.

The network may then complement/update at least one of the V2N message or the virtual message based on a matching result (S205). The update of the at least one message may be performed based on the V2N header of each V2N message without decoding/encoding the payload of the V2N message, as described above. For example, as described with reference to FIGS. 17 and 18, the network may identify dummy bits (or a null field) based on the V2N header included in one of the matched V2N message and virtual V2N message, extract bits corresponding to the dummy bits from the payload of the other V2N message, and replace the dummy bits of the one V2N message with the extracted bits, thereby complementing/updating the one V2N message without decoding/encoding the payload.

Specifically, the network may determine whether there are bits or a field requiring complementation in the payload of each of the V2N message and the virtual V2N message based on the V2N header included in the message. For example, as described with reference to FIGS. 17 and 18, the payload of the V2N message and/or the virtual V2N message may include dummy bits (or a null field) or an empty field for information that is difficult for each device to obtain. In this case, the header of each V2N message may further include information about a start bit position and a bit length for specifying the dummy bits and the empty field in the payload. The network may determine whether to complement or update each V2N message based on whether the V2N header of the V2N message includes the start bit position and the bit length (or the start bit position and the field length of the empty field). When the V2N header of each V2N message includes the start bit position and the bit length (StartPoint and StartLength), the network may specify/identify the position of the dummy bits and/or the empty field in the payload of the V2N message or the virtual V2N message based on the information about the start bit position and the bit length. The network may extract bits and/or field information corresponding to the specified dummy bits and/or empty field from the other matched V2N message, and complement/update the V2N message including the dummy bits and/or empty field based on the extracted bits and/or field information.

For example, when the V2N header of the V2N message transmitted by the second device includes information for identifying the dummy bits, the network may identify the positions of the dummy bits in the payload based on the start position and bit length (or bit size) of the dummy bits included in the V2N header of the V2N message, and extract bits or data at positions corresponding to the positions of the specified dummy bits in the payload of the matching virtual V2N message. The network may effectively complement/update the V2N message without decoding/encoding the payload by replacing the dummy bits included in the payload of the V2N message with the extracted bits or data.

Alternatively, when the empty field exists in the payload of the V2N message transmitted by the second device, the network may identify the start position and field length of the empty field based on the V2N header of the V2N message, and extract corresponding field data or field information from the virtual V2N message based on the start position and field length of the identified empty field. The network may complement/update the V2N message without an encoding/decoding procedure by adding the extracted field data or field information to the payload of the V2N message.

Subsequently, the network may transmit each of the updated or complemented V2N message and the virtual V2N message to neighboring UEs located in the specific geographical area (S207).

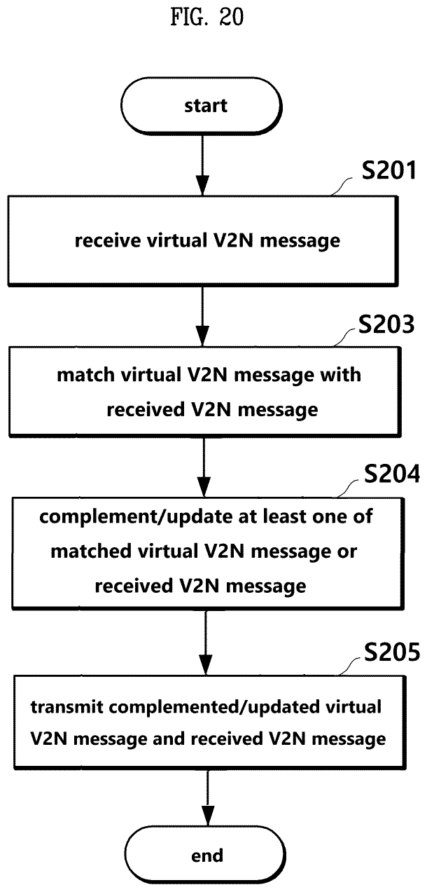

FIG. 22 is a diagram illustrating a method of transmitting a V2N message to a network by a first device.

Referring to FIG. 22, the first device may obtain an image of a specific area through a sensor (such as a camera) and detect an object based on the obtained image (S211). The first device may generate a virtual V2X message for the detected object (S213). For example, the first device may obtain an image of a specific area (such as an area including a road) through the camera and detect objects such as vehicles and/or VRUs based on the image. For each of the detected objects, the first device may virtually generate a V2X message predicted to be transmitted by the detected object.

Subsequently, the first device may transmit a virtual V2N message including the generated virtual V2X message to the network (S215). For example, the first device may include the virtually generated V2X message in payload of the virtual V2N message and transmit it to the network.

The virtual V2N message may include first location information about the object and coverage information about a distance to a closest neighboring object. In addition, the virtual V2N message may be matched with another V2N message in the network, as described above with reference to FIGS. 11 to 20, and missing information may be added based on the matched V2N message, for update. The virtual V2N message may be matched with the other V2N message by the network based on the first location information, the coverage information, and second location information included in the V2N message. Alternatively, the first device may directly perform the matching and the updating of the message.

As such, the RSU may generate and transmit a virtual V2N message for a detected device or vehicle in the SoftV2X system, thereby effectively providing a safety service based on SoftV2X even in a road and surrounding environment where non-V2X vehicles and VRUs coexist. Further, the SoftV2X server may significantly improve the performance of a V2N message and provide an efficient SoftV2X service by complementing and retransmitting the V2N message and the virtual V2N message which match each other. Alternatively, the matched V2N messages may be quickly complemented and/or updated without an encoding/decoding procedure by additionally defining indication information for a bit position or field position for missing information in the V2N header of a V2N message.

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

FIG. 22 illustrates a communication system applied to the present disclosure.

Referring to FIG. 22, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

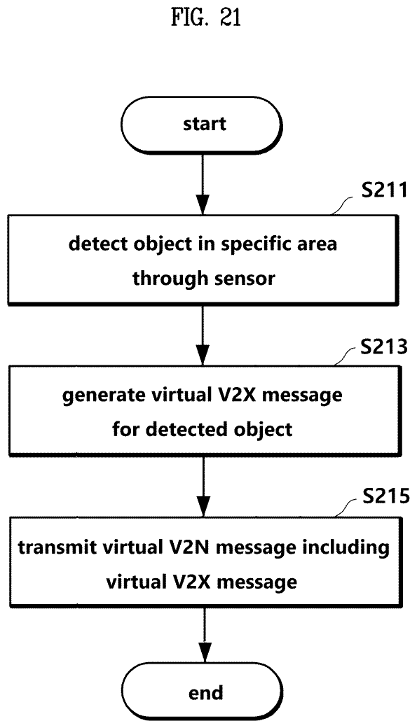

FIG. 23 illustrates a wireless device applicable to the present disclosure.

Referring to FIG. 23, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 22.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device or network 100 may include the processor 102 connected to the transceiver 106, and the memory 104. The memory 104 may include at least one program for performing an operation related to the embodiments described above with reference to FIGS. 11 to 20.

The processor 102 may control the transceiver 106 to receive a virtual V2N message virtually generated for an object detected through a sensor from a first device, match the virtual V2N message with a V2N message received from a second device, update at least one of the virtual V2N message or the V2N message which match each other, and transmit the updated virtual V2N message and V2N message. The virtual V2N message may include first location information about the object and coverage information about a distance to a closest neighboring object. The virtual V2N message may be matched with the V2N message based on the first location information, the coverage information, and second location information included in the V2N message.

Alternatively, the processor 102 and the memory 104 may be included in a chipset that transmits a first message. The chipset may include at least one processor and at least one memory operatively connected to the at least one processor and when executed, causing the at least one processor to perform operations. The operations may include receiving a virtual V2N message virtually generated for an object detected through a sensor from a first device, matching the virtual V2N message with a V2N message received from a second device, updating at least one of the virtual V2N message or the V2N message which match each other, and transmitting the updated virtual V2N message and V2N message. The virtual V2N message may include first location information about the object and coverage information about a distance to a closest neighboring object. The virtual V2N message may be matched with the V2N message based on the first location information, the coverage information, and second location information included in the V2N message.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

A first device, which is the second wireless device 200, may include the processor 202, the transceiver 206, and the memory 204. The processor 202 may detect an object using a sensor included in the first device, virtually generate a V2X message for the detected object, and control the transceiver 206 to transmit a virtual V2N message including the generated V2X message to the first wireless device or network 100. The virtual V2N message may include first location information about the object and coverage information about a distance to a closest neighboring object. The virtual V2N message may be updated based on the other matched V2N message in the network. The virtual V2N message may be matched with the other V2N message based on the first location information, the coverage information, and second location information included in the V2N message.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

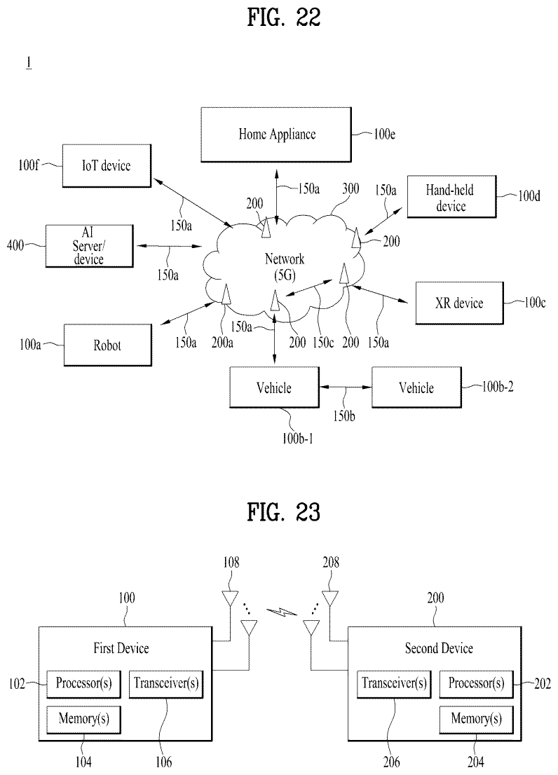

FIG. 24 illustrates another example of a wireless device applied to the present disclosure. The wireless device may be implemented in various forms according to a use-case/service (refer to FIG. 22)

Referring to FIG. 24, wireless devices 100 and 200 may correspond to the wireless devices 100 and 200 of FIG. 23 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 23. For example, the transceiver(s) 114 may include the one or more transceivers 106 and 206 and/or the one or more antennas 108 and 208 of FIG. 23. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 22), the vehicles (100b-1 and 100b-2 of FIG. 22), the XR device (100c of FIG. 22), the hand-held device (100d of FIG. 22), the home appliance (100e of FIG. 22), the IoT device (100f of FIG. 22), a digital broadcast terminal, a hologram device, a public safety device, an MTC device, a medicine device, a fintech device (or a finance device), a security device, a climate/environment device, the AI server/device (400 of FIG. 22), the BSs (200 of FIG. 22), a network node, etc. The wireless device may be used in a mobile or fixed place according to a use-example/service.

In FIG. 24, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

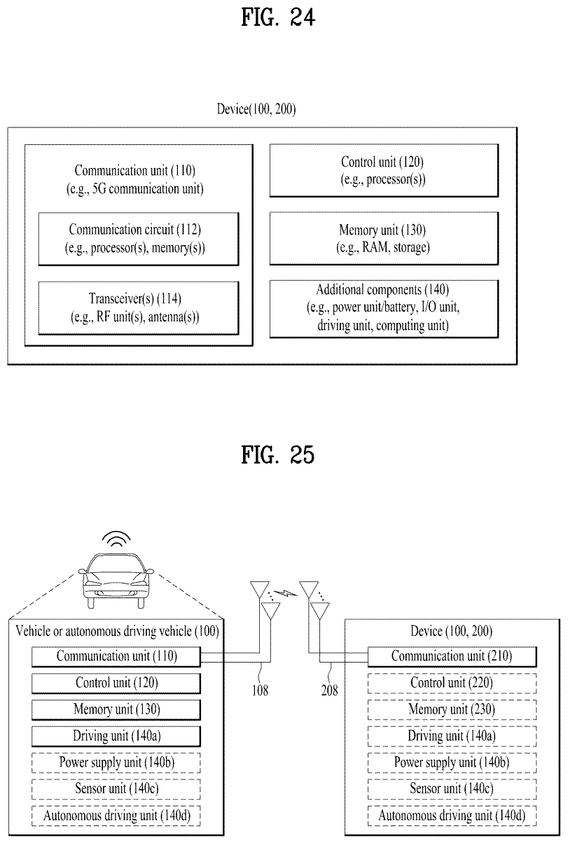

FIG. 25 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 25, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 22, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure. For example, those skilled in the art may use the components described in the foregoing embodiments in combination. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The above-described embodiments of the present disclosure are applicable to various mobile communication systems.

1. A method by a network comprising:
receiving a virtual vehicle to network (V2N) message including a virtually generated vehicle to everything (V2X) message for an object detected through a sensor from a first device;
matching the virtual V2N message with a V2N message received from a second device; and
updating at least one of the matched virtual V2N message or V2N message, and transmitting the updated virtual V2N message and V2N message,
wherein the virtual V2N message includes first location information about the object and coverage information about a distance to a closest neighboring object, and
wherein the virtual V2N message is matched with the V2N message based on the first location information, the coverage information, and second location information included in the V2N message.

2. The method of claim 1, wherein based on a distance between the first location information and the second location information being smaller than the distance included in the coverage information, the virtual V2N message matches the V2N message.

3. The method of claim 1, wherein based on the distance between the first location information and the second location information being smaller than the distance included in the coverage information to which a first weight is applied, the virtual V2N message matches the V2N message, and
wherein the first weight is determined based on a density of neighboring devices of the detected object.

4. The method of claim 1, wherein a header of one of the V2N message and the virtual V2N message includes information about a start bit position and a bit length of dummy bits included in payload.

5. The method of claim 4, wherein the network specifies positions of the dummy bits in the payload based on the start bit position and the bit length, and updates the one message without decoding the payload based on the specified positions of the dummy bits.

6. The method of claim 5, wherein based on the one message being the V2N message, the network extracts bits at positions corresponding to the dummy bits from payload included in the virtual V2N message, and updates the V2N message by replacing the dummy bits with the extracted bits.

7. The method of claim 1, wherein a header of one of the V2N message and the virtual V2N message includes information about a start position and a field length of an empty field omitted in payload.

8. The method of claim 7, wherein the network specifies a position of the empty field in the payload based on the start position and the field length, and updates the one message without decoding the payload based on the specified position of the empty field.

9. The method of claim 8, wherein based on the one message being the virtual V2N message, the network extracts field information at a position corresponding to the empty field from payload included in the V2N message, and updates the virtual V2N message by adding the field information to the empty field.

10. The method of claim 1, wherein the virtual V2N message and the V2N message include payload for a personal safety message (PSM) or basic safety message (BSM) related to vehicle to vehicle communication.

11. (canceled)

12. A network comprising:
a radio frequency (RF) transceiver; and
a processor connected to the RF transceiver,
wherein the processor controls the RF transceiver to receive a virtual V2N message including a virtually generated vehicle to everything (V2X) message for an object detected through a sensor from a first device, matches the virtual V2N message with a V2N message received from a second device, updates at least one of the matched virtual V2N message or V2N message, and transmits the updated virtual V2N message and V2N message, and
wherein the virtual V2N message includes first location information about the object and coverage information about a distance to a closest neighboring object, and the virtual V2N message is matched with the V2N message based on the first location information, the coverage information, and second location information included in the V2N message.

13. (canceled)

14. A method by a first device comprising:
generating a virtual vehicle to everything (V2X) message for an object detected through a sensor; and
transmitting a virtual vehicle to network (V2N) message including the virtual V2X message to the network,
wherein the virtual V2N message includes first location information about the object and coverage information about a distance to a closest neighboring object,
wherein the virtual V2N message is updated based on another V2N message matched by the network, and
wherein the virtual V2N message is matched with the other V2N message by the network based on the first location information, the coverage information, and second location information included in the V2N message.

15.-17. (canceled)
